(19) United States
(12) Patent Application Publication
(10) Pub. No.: US 2004/0030649 A1
(43) Pub. Date: Feb. 12, 2004

(54) System and method of application processing

(76) Inventors: Chris Nelson, Bozeman, MT (US); Tom Johnson, Bozeman, MT (US); Jennifer Augustine, Bozeman, MT (US); Jim Palakovich, Bozeman, MT (US); Paul Kneeland, Silverton, OR (US); Andre Toulouse, Bozeman, MT (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/427,836

(22) Filed: May 1, 2003

Related U.S. Application Data
(60) Provisional application No. 60/380,100, filed on May 6, 2002.
(60) Provisional application No. 60/391,473, filed on Jun. 25, 2002.
(60) Provisional application No. 60/391,543, filed on Jun. 25, 2002.

(51) Int. Cl. G06F 17/60

(52) U.S. Cl. 705/44

(57) ABSTRACT

The present invention provides systems and methods for application processing. The present invention receives a request to process an application. In response to the request, the system validates the application data and requests a reporting bureau to provide report data associated with the applicant associated in the application data. After receiving reporting data from the reporting bureau, the system submits the application data and reporting data to a decision engine. The system is capable of interfacing with one or more of a plurality of decision engines. The system receives a preliminary decision from the decision engine. If the preliminary decision indicates approval, the system issues approval documents. If the preliminary decision indicates rejection, the system issues rejection documents. If the decision engine is not able to issue an approval or a rejection, the system directs the application to a pending application queue. Such pending applications may either be automatically rejected/accepted or be manually examined.

### CROSS REFERENCE TO RELATED APPLICATION AND CLAIM OF BENEFIT

This application claims the benefit of co-pending United States Provisional patent applications entitled “Loan Origination and Application Processing System” filed on May 6, 2002 and assigned serial number 60/380,100, “Kairos Base System” filed on Jun. 25, 2002 and assigned serial No. 60/391,473, and “Kairos Workflow” filed on Jun. 25, 2002 and assigned serial No. 60/391,543, which are incorporated by reference in their entirety as if fully set forth herein.

### FIELD OF THE INVENTION

The present invention relates generally to application processing systems and, more particularly, to automated application processing systems associated with decision engines.

### BACKGROUND OF THE INVENTION

Business institutions, such as banks, extend credit or lend money to consumers. Essentially, these business institutions lend money to make money. Deciding which consumers are credit-worthy is not always an easy task. Historically, lenders relied on human judgment to determine who received credit. Using past experience as a guide, lenders observed consumer credit behavior as the standard for judging new consumers. The decision could be based on subjective criteria such as a consumer having too much debt or too many late payments. Often, lenders made decisions based on personal opinion, which frequently had little relevance to a consumer's ability to repay debt. The entire credit approval process was very slow and unreliable, because of human error and bias.

In response to the rise in demand for a more reliable source of consumer credit information, credit bureaus developed which stored credit history information. Three major national consumer bureaus presently exist in the United States. Creditors provide the bureaus with information about the consumers' payment history. The bureaus compile the information and obtain public record information to include in credit reports. The bureaus then make the reports available to creditors for deciding whether to approve new applicants for credit. Credit reports contain useful information for creditors to examine in determining the credit-worthiness of an applicant. For example, a credit report provides information such as the number of times the applicant has recently applied for credit and any public records related to the applicant's credit. Credit reports also include personal information, credit history information, public record information, and credit inquiry information. The personal information found in a credit report includes the applicant's name, address, phone number, social security number, current and previous employers, and previous home addresses. The credit history information includes late payments, outstanding debt, and the total amount of credit available to the applicant. The public records information includes any filings by the applicant for bankruptcy and court judgments against the applicant. The credit inquiry information provides lenders with a list of recent inquiries for credit. Such inquiries let a business institution decide whether the applicant is desperate to obtain credit, is trying to defraud the credit system, or is simply trying to obtain too much credit.

Over time, lenders created a standard on how to make credit decisions by using a point system. The point system scores different variables found on the consumer's credit report. Variables in the credit report used to calculate a credit score include: number and severity of late payments, the total amount of debt, the number of accounts, the type of accounts, the age of the accounts, and any recent inquiries. The goal of the point system is to accurately predict the future credit behavior of an applicant. The point system or credit score assists lenders in determining the risk involved in extending credit to a certain consumer. Consumers also benefit from the scoring system, because now the decision to extend credit is based on the ability to repay debt, and not based on subjective criteria such as race, religion, national origin, sex, and marital status.

In addition to the credit score determined by the credit report, each business institution may have its own set of decisioning criteria used in conjunction with the credit information to determine whether to approve or reject an application. Decisioning criteria consist of custom thresholds and requirements that establish a lending institution's rules, specifications, or tests used to reach a conclusion on an issue under consideration. In the lending industry, the decisioning criteria govern whether an individual is granted or denied credit. After receiving a credit report from a credit bureau, the business institution applies its criteria to make a decision on credit approval. For example, a business institution may have decisioning criteria that restricts credit limits offered to applicants who have poor payment histories, while offering premium rates or products to applicants with exceptional credit histories.

As the lending industry becomes larger, the need for efficient loan application processing becomes more apparent. Accordingly, most lending institutions look to automate the loan application approval process.

Two options exist for business institutions for accessing credit bureaus and applying decisioning criteria: “in-house” software and third party software. While both options may be suitable for accessing and evaluating credit information, both have certain disadvantages. An “in-house” software solution may provide the greatest control for business institutions, but the costs of developing the software, purchasing the hardware, and hiring technical staff are expensive. Often contracting a third party to develop, implement, and host the software solution may be the most cost-efficient solution, but typically this requires use of the decision engine operated by the third party. A “decision engine” is the term used to describe the system employed to retrieve credit information, apply decisioning criteria to the credit information, and provide the appropriate result to the business institution requesting the decision. Typically, a decision engine comprises hardware and software.

Additionally, similar problems exist generally with respect to application processing across all industries. Application processing often requires significant human resources, which are susceptible to bias and inconsistent decision making. Such resources may be reduced through the efficient use of an automated application processing system.

Accordingly, there is a need in the art for a system method of processing applications that provides high levels of customization.

Additionally, there is a need in the art for an application processing system that is capable of interacting with multiple decision engines.

Further, there is a need in the art for an application processing system that provides a centralized computer system for interacting with numerous lending institutions and financial services vendors to efficiently and economically implement each institution's decisioning criteria.

### SUMMARY OF THE INVENTION

The present invention overcomes the limitations in the prior art by providing systems and methods for application processing. The loan application system, according to an exemplary embodiment of the present invention, receives a request to process an application. In response to the request, the system validates the application data and requests a reporting bureau to provide report data associated with the applicant identified in the application data. After receiving reporting data from the reporting bureau, the system submits the application data and reporting data to a decision engine. The system is capable of interfacing with one or more of a plurality of decision engines. The system receives a preliminary decision from the decision engine. If the preliminary decision indicates approval, the system issues approval documents. If the preliminary decision indicates rejection, the system issues rejection documents. If the decision engine is not able to issue an approval or a rejection, the system directs the application to a pending application queue. Such pending applications may either be automatically rejected/accepted or be manually examined.

### BRIEF DESCRIPTION OF DRAWINGS

FIG. 1 is a system diagram that illustrates an exemplary environment suitable for implementing various embodiments of the present invention.

FIG. 2 is a block diagram that illustrates the conceptual components of an application processing system in an exemplary embodiment of the present invention.

FIG. 3 is a system diagram that illustrates the components of an application processing system in an exemplary embodiment of the present invention.

FIG. 4 is a flow diagram illustrating the steps of application processing according to an exemplary embodiment of the present invention.

FIG. 5 is a flow diagram illustrating the steps of application processing and checking according to an exemplary embodiment of the present invention.

FIG. 6 is a flow diagram illustrating the steps of pre-qualifying application processing according to an exemplary embodiment of the present invention.

### DETAILED DESCRIPTION OF INVENTION

Referring now to the drawings, in which like numerals refer to like parts throughout the several views, exemplary embodiments of the present invention are described. Throughout the detailed description, reference will be made to the operation of the present invention when embodied within a computing device. Computing devices may include, but are not limited to, personal computers, mainframe computers, servers, and any other device capable of executing the software associated with the present invention. Additionally, while the detailed description focuses primarily on the present invention embodied in a loan application system, the invention may be applied to any form of application processing and the loan processing example is intended as an exemplary embodiment and in no way limits the application of the invention. However, it should be understood that the features and aspects of the present invention can be ported into a variety of systems and system configurations and any examples provided within this description are for illustrative purposes only.

In general, the present invention can be described as a system and method for application processing that can be accessed and exploited from a single platform to facilitate operational needs for a user or company.

Exemplary Environment

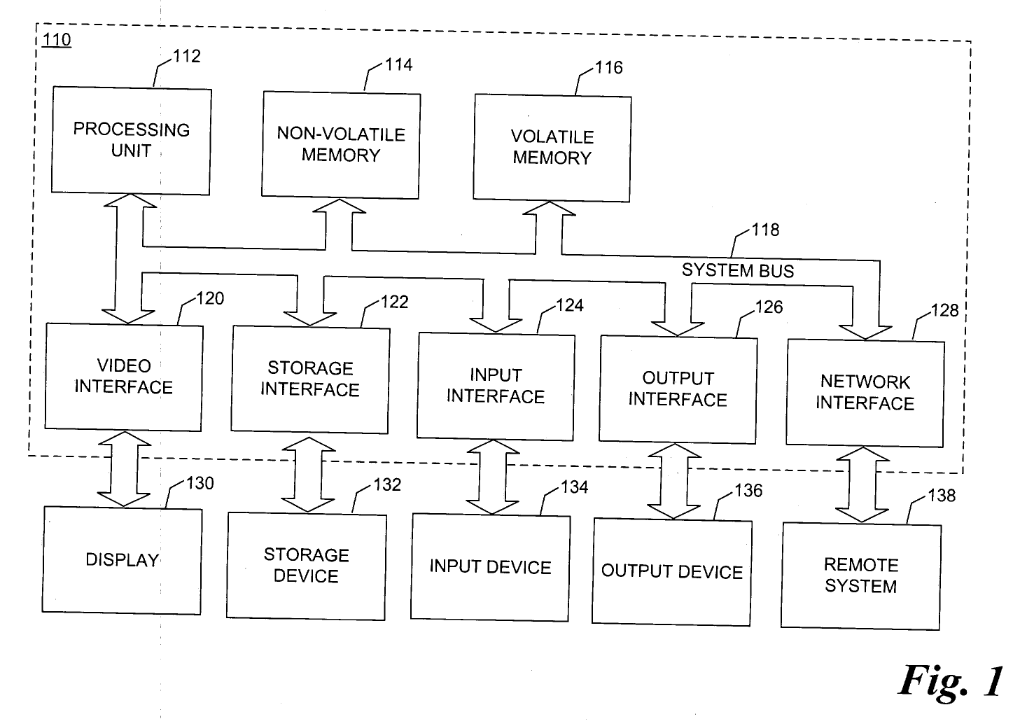

FIG. 1 is a system diagram that illustrates an exemplary environment suitable for implementing various embodiments of the present invention. FIG. 1 and the following discussion provide a general overview of a platform onto which the invention, or portions thereof, may be integrated, implemented and/or executed. Although in the context of the exemplary environment the invention will be described as consisting of instructions within a software program being executed by a processing unit, those skilled in the art will understand that portions of the invention, or the entire invention itself may also be implemented by using hardware components, state machines, or a combination of any of these techniques. In addition, a software program implementing an embodiment of the invention may run as a stand-alone program or as a software module, routine, or function call, operating in conjunction with an operating system, another program, system call, interrupt routine, library routine, or the like. The term program module will be used to refer to software programs, routines, functions, macros, data, data structures, or any set of machine readable instructions or object code, or software instructions that can be compiled into such, and executed by a processing unit.

Those skilled in the art will appreciate that the system illustrated in FIG. 1 may take on many forms and may be directed towards performing a variety of functions. Generally, the system illustrated in FIG. 1 may be any system that includes a computer processor. Examples of such forms and functions include, but are not limited to, personal computers, hand-held devices such a personal data assistants, note-book computers, lap-top computers, mainframe computers, servers and a variety of other applications, each of which may serve as an exemplary environment for embodiments of the present invention.

The exemplary system illustrated in FIG. 1 includes a computing device 110 that is made up of various components including, but not limited to a processing unit 112, non-volatile memory 114, volatile memory 116, and a system bus 118 that couples the non-volatile memory 114 and volatile memory 116 to the processing unit 112. The non-volatile memory 114 may include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), FLASH memory, bubble memory, and battery backed random access memory (RAM). The non-volatile memory 114 provides storage for power-on and reset routines (bootstrap routines) that are invoked upon applying power or resetting the computing device 110. In some configurations the non-volatile memory 114 provides the basic input/output system (BIOS) routines that are utilized to perform the transfer of information between elements within the various components of the computing device 110.

The volatile memory 116 may include, but is not limited to, a variety of memory types and devices including, but not limited to, random access memory (RAM), dynamic random access memory (DRAM), FLASH memory, EEPROM, bubble memory, registers, or the like. The volatile memory 116 provides temporary storage for routines, modules, functions, macros, data etc. that are being or may be executed by, or are being accessed or modified by the processing unit 112. In general, the distinction between non-volatile memory 114 and volatile memory 116 is that when power is removed from the computing device 110 and then reapplied, the contents of the non-volatile memory 114 remain in tact, whereas the contents of the volatile memory 116 are lost, corrupted, or erased.

The computing device 110 may access one or more external display devices 130 such as a CRT monitor, LCD panel, LED panel, electro-luminescent panel, or other display device, for the purpose of providing information or computing results to a user. In some embodiments, the external display device 130 may actually be incorporated into the product itself. The processing unit 112 interfaces to each display device 130 through a video interface 120 coupled to the processing unit 110 over the system bus 118.

The computing device 110 may send output information, in addition to the display 130, to one or more output devices 136 such as a speaker, modem, printer, plotter, facsimile machine, RF or infrared transmitter, computer or any other of a variety of devices that can be controlled by the computing device 110. The processing unit 112 interfaces to each output device 136 through an output interface 126 coupled to the processing unit 112 over the system bus 118. The output interface 126 may include one or more of a variety of interfaces, including but not limited to, cable modems, DLS, T1, V series modems, an RS-232 serial port interface or other serial port interface, a parallel port interface, a universal serial bus (USB), a general purpose interface bus (GPIB), an optical interface such as infrared or IRDA, an RF or wireless interface such as Bluetooth, or other interface.

The computing device 110 may receive input or commands from one or more input devices 134 such as a keyboard, pointing device, mouse, modem, RF or infrared receiver, microphone, joystick, track ball, light pen, game pad, scanner, camera, computer or the like. The processing unit 112 interfaces to each input device 134 through an input interface 124 coupled to the processing unit 112 over the system bus 118. The input interface 124 may include one or more of a variety of interfaces, including but not limited to, cable modems, DSL, T1, V series modems, an RS-232 serial port interface or other serial port interface, a parallel port interface, a universal serial bus (USB), a general purpose interface bus (GPIB), an optical interface such as infrared or IrDA, an RF or wireless interface such as Bluetooth, or other interface.

It will be appreciated that program modules implementing various embodiments of the present invention may be may be stored in the non-volatile memory 114, the volatile memory 116, or in a remote memory storage device accessible through the output interface 126 and the input interface 124. The program modules may include an operating system, application programs, other program modules, and program data. The processing unit 112 may access various portions of the program modules in response to the various instructions contained therein, as well as under the direction of events occurring or being received over the input interface 124.

Application Processing System

The present invention is directed to an application processing system designed to provide control and flexibility to a variety of consumers. The application processing system may be utilized in various fields including, but not limited to, loan origination and application processing, financial institution application processing, home equity application processing, consumer loan application processing, credit card application processing, drivers license application processing, hunting license application processing, vehicle tag application processing, income tax application processing, employment hiring application processing, educational admissions application processing, and the various application processing needs of companies and government agencies. While those skilled in the art of computer system design and application processing design will recognize that the present invention may be applied to numerous application systems, the present disclosure focuses on an exemplary embodiment of the present invention directed toward loan origination and application processing. The disclosure of loan origination and application processing should in no way limit the applicability of the present invention to other types of application processing.

Notably, a combination of a relational database design with multiple web-based management components provides financial institutions the ability to automate nearly every aspect of loan processing. In an exemplary embodiment of the present invention, the system is compatible with and is capable of interacting with multiple decision engines. Typically, a loan origination and application processing system will include a flexible user management tool allowing administrators to create customized permission sets to ensure security and stability. Additionally, a reporting function is often included to provide real-time data analysis and system performance monitoring.

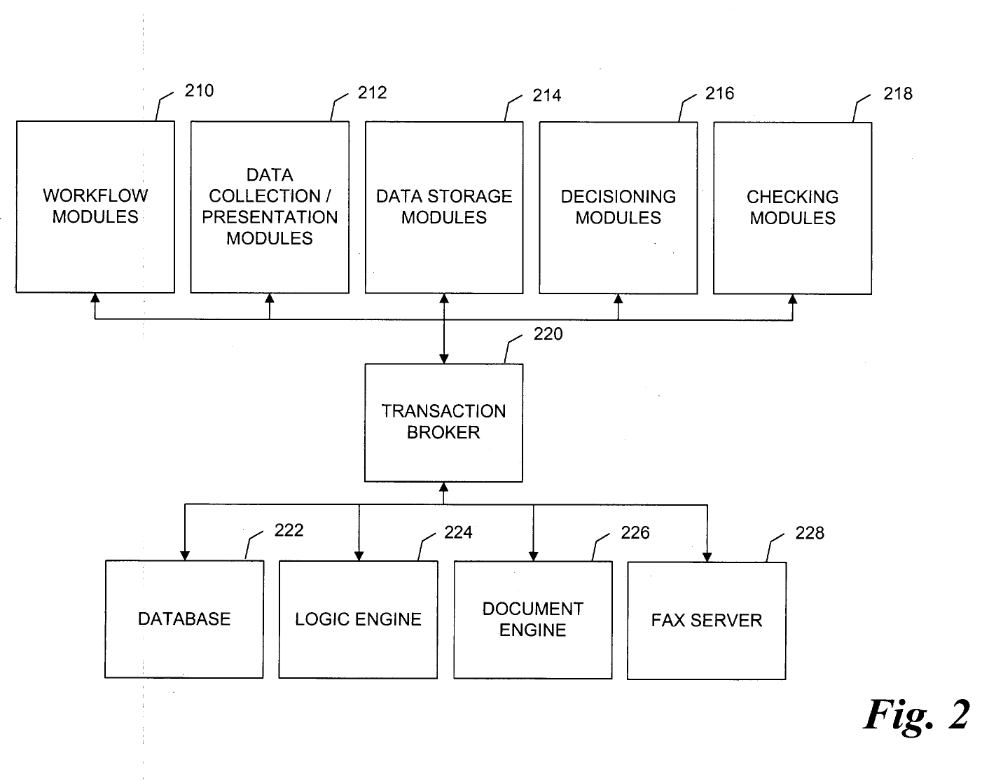

FIG. 2 is a block diagram that illustrates the conceptual components of an application processing system in an exemplary embodiment of the present invention. The illustrated system generally includes multiple components in communication with several modules and with each other. A transaction broker 220 provides a system-wide interface daemon that serves as the data conversion center.

A database 222 may be any memory device capable of storing and retrieving data including, but not limited to, random access memory (RAM), flash memory, magnetic memory devices, optical memory devices, hard disk drives, removable volatile or non-volatile memory devices, optical storage mediums, magnetic storage mediums, hard disks, RAM memory cards, etc. Alternatively, the database 222 may be a remote storage facility accessible through a wired and/or wireless network system. In another embodiment of the present invention, the database 222 may be a memory system comprising a multi-stage system of primary and secondary memory devices, as mentioned above. The primary memory device and secondary memory device may operate as a cache for the other. Also, the secondary memory device may serve as a backup to the primary memory device. In yet another embodiment of the present invention, the database 222 may be a memory device configured as a simple database file. Additionally, the database 222 may be a relational database using a structured-query-language (SQL). One skilled in the art will recognize that the term database and the term data storage unit may be used interchangeably as currently defined.

A logic engine 224 is provided to apply processing rules and to trigger actions to be performed in accordance with the rules. The logic engine's 224 functionality is typically incorporated into the system workflow and operates in cooperation with the transaction broker 220 to process logic decisions.

A document engine 226 allows automatic document generation and printing of documents for every application processed by the system. Additionally, the document engine 226 may be used to generate letters regarding approved, pre-approved, declined, or still pending applications.

A fax server 228 provides the system with a device capable of faxing documents to external sources.

One skilled in the art will recognize that the transaction broker 220, the database 222, the logic engine 224, the document engine 226, and the fax server 228 may communicate via any desired and appropriate communication device and technique including, but not limited to, intranet, Internet, local area network (LAN), wide area network (WAN), copper wire, coaxial cable, fiber optic cable, infrared devices, and RF signals.

The application processing system also includes several modules in communication with the above mentioned components. The workflow 210 module is an automated application routing and queuing function that coordinates the movements of applications through the system. The workflow 210 utilizes queues and tasks to organize the application process. The data collection/presentation 212 module is designed to collect and present data in proper and necessary formats. The data storage 214 module provides the interface to the database 222 for data storage. The data storage 214 module formulates proper database queries and commands to retrieve and store data. The decisioning 216 modules provide the format of data presented to and received from a decisioning service. The decisioning 216 module assists the transaction broker 220 in data manipulation and translation for multiple decisioning services. The checking 218 module provides multiple data checking functions to apply to applications for processing. The checking 218 modules may include, but are not limited to, duplicate check, fraud check, registered officer check, employee check, and preferred customer check.

In an exemplary embodiment of the present invention, the loan origination and application processing system comprises a series of distinct, stand-alone segments that work together through various system-internal interfaces. The system may include a database 222 that stores information for the system to process. The invention employs system interfaces for linking objects, internal interfaces for direct connections to customers and other systems, and external interfaces for electronic transfer between the system and outside vendors. Depending on the needs of the lending institution, the segments may be combined into different configurations to accommodate a wide range of customer requirements and overall system functionality. The segments may include, but are not limited to, application entry, pre-bureau edits, credit processing and auto-decisioning, application processing and review, calculators, workflow 210, logic engine 224, users and organizations, products and promotion administration, rates, vendors and data sources, document fulfillment, closing functions, booking functions, reporting, screen permissions, product parameter permissions, and OFAC and USA PATRIOT Act compliance.

Each graphical user interface (GUI) utilized by the system is specifically designed to match the customer's visual and functional requirements. Certain functionality remains constant in the graphical user interfaces, including certain performance features, available GUI-related options, and basic GUI design. Each graphical user interface utilizes conventional screen configuration, customizable drop-down menus, and drag-and-drop capabilities common in software applications.

In an exemplary embodiment of the present invention, the loan origination and application processing system includes a transaction broker 220 that provides a system-wide interface daemon that serves as the data conversion center. In most configurations, every transaction on the system uses the transaction broker 220 as an interpreter. The transaction broker 220 binds ports and calls modules that perform necessary data conversion. The transaction broker 220 uses any standard Internet protocol, such as HTTP, FTP or socket connections, to transfer data internally and externally. Additionally, the transaction broker 220 may communicate directly with mainframes or legacy machines without the above mentioned protocols. Data re-formatting occurs according to pre-configured modules that are custom-built interfaces to the various process requirements. The transaction broker 220 provides the framework through modules that perform detailed work for a transaction. Such a framework allows for a highly configurable and dynamic transaction processing system. The transaction broker 220 allows the application process to be distributable.

When the transaction broker 220 receives a request for data retrieval, the incoming transaction requests are passed to the appropriate module and the data is automatically converted to the appropriate format for the specific process or vendor. Once a response is generated, the data is converted back to the same format required by the requesting process. Such data conversion includes preparing information to be inserted into the system database 222, such as preparing proper SQL statements.

In an exemplary embodiment of the present invention, the loan origination and application processing system connects to the transaction broker 220 via a socket connection and transmits a request containing the information necessary for the transaction broker 220 to determine which module to access for data conversion. The module converts the request into the appropriate format for the process or vendor before the request is sent to the appropriate process or vendor.

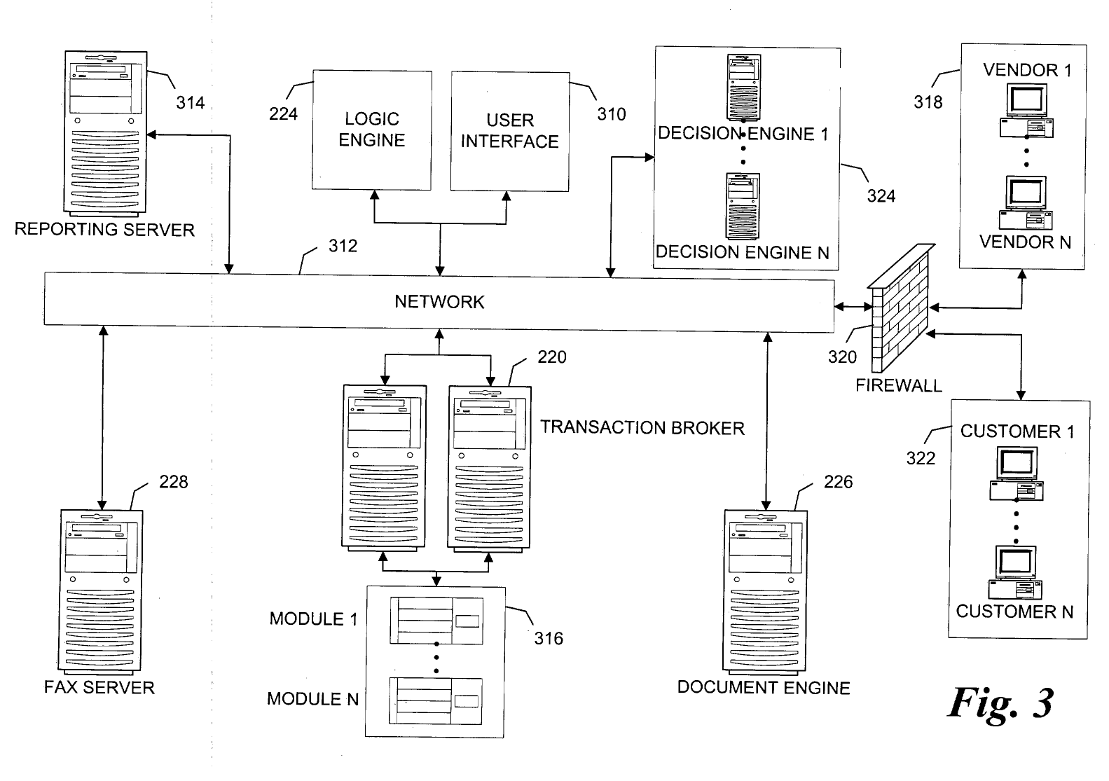

FIG. 3 is a system diagram that illustrates the components of an application processing system in an exemplary embodiment of the present invention. The application processing system communicates to each component member via a network 312. The network 312 may include, but is not limited to, intranet, Internet, local area network (LAN), wide area network (WAN), or a remote network of any combination thereof. Customer computers 322 and vendor computers 318 communicate with the application processing system through a firewall 320. The firewall 320 may be implemented with hardware or software, or a combination thereof, and prevents unauthorized access to and from the system network 312.

The system contains a user interface 310 for users to access the multiple components connected to the network 312. Customer computers 322 and vendor computers 318 may communicate with the system via the user interface 310. The user interface 310 receives data from the user and provides the data to the system for processing. The transaction broker 220 is in communication with the user interface 310. Multiple modules 316 are in communication with the transaction broker 220 and provide the system with a variety of functionality. More specifically, the multiple modules 316 assist the transaction broker 220 in formatting data into specific formats for other components of the system. A logic engine 224 is in communication with the transaction broker 220. The logic engine 224 implements the system workflow 210 by applying rules to the data being processed. The logic engine 224 manages the stages of the application processing.

Multiple decision engines 324 communicate with the transaction broker 220 through the network 312. A decision engine 324 may reside internally within the network 312 or externally outside the network 312, thus communicating through the firewall 320. Upon receiving a request from the transaction broker 220, a decision engine 324 implements a unique set of decisioning criteria and returns the result to the transaction broker 220. The transaction broker 220 may communicate with more than one decision engine 324 to apply different decisioning criteria. In an exemplary embodiment of the present invention, the application processing system is operative to interface with a variety of different decision engines. A particular system may communicate with one or more decision engines. Preferably, each system is capable of interfacing with a plurality of different decision engines to allow greater flexibility for users to select a decision engine that is capable of communicating with the application processing system. In the event that a user desires to interface with a decision engine that is not initially compatible with the system, an exemplary embodiment of the present invention allows customization of the interface to communicate with additional decision engines.

The document engine 226 communicates through the network 312 to the transaction broker 220. The document engine 226 provides document fulfillment for the application processing system, while additionally providing legal compliance contracts. The document engine 226 receives a request for document fulfillment from the transaction broker 220 and provides the transaction broker 220 with the necessary document templates for processing.

The fax server 228 communicates through the network 312 to the transaction broker 220. The fax server 228 provides facsimile functionality to the application processing system. The fax server 228 receives data from the transaction broker 220 and converts the data into proper facsimile format to be provided to a particular destination.

The reporting server 314 communicates through the network 312 to the transaction broker 220. The reporting server 314 offers instant access to critical application data in a real-time environment by providing a wide range of pre-prepared reports and ad hoc queries. The reporting server 314 generates the reports after receiving a request from the transaction broker 220.

One skilled in the art will recognize that the above mentioned components may communicate via any desired and appropriate communication devices and techniques, as previously mentioned.

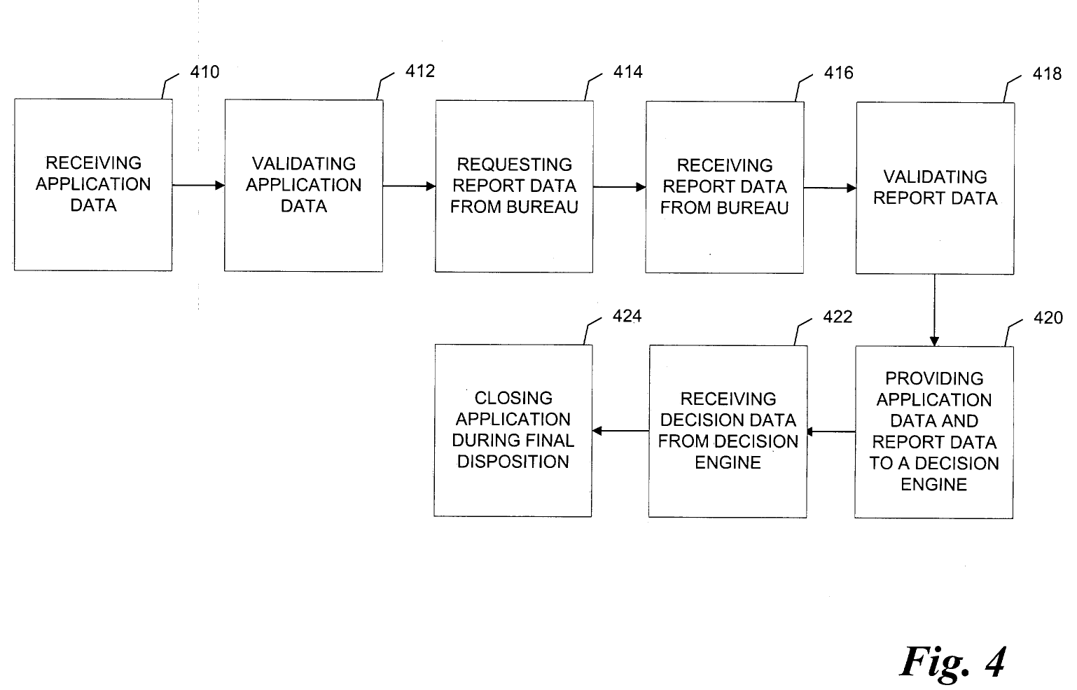

FIG. 4 is a flow diagram illustrating the steps of application processing according to an exemplary embodiment of the present invention. The system receives application data 410, typically from a user, for processing. Upon receiving the application data 410, the system validates the application data 412 to ensure that application data is correct and sufficient for processing. The system requests report data from a bureau 414 by providing the bureau with application data. A bureau generally provides information useful in processing applications. Generally, a bureau includes any depository of information. While a bureau can provide any type of information, in an exemplary embodiment of the present invention the system requests report data 414 from a credit reporting bureau. Common credit bureaus include EQUIFAX™, TRANSUNION™, and EXPERIAN™. One skilled in the art will recognize that a bureau can provide information in a variety of fields. For example, a government checking bureau may report criminal records to employers or traffic violations to an agency that issues driver's licenses. After the system requests report data 414, the system receives the report data from the bureau 416. The report data is validated 418 to ensure that the report data is correct and complete. Alternatively, steps 414, 416, and 418 may be performed by the decision engine 324. Next, the system provides the application data and report data 420 to a decision engine for processing. After the decision engine has processed the application data and report data, the system receives decision data from the decision engine 422. Decision data may include, but is not limited to, a success status, a failure status, or a pending status. The pending status may require that the application be submitted for further review. The system then closes the application for final disposition 424. Closing the application 424 may include providing application data to the document engine 226 for document fulfillment. The document production engine 226 may produce documents such as approval documents, failure documents, or pending status documents.

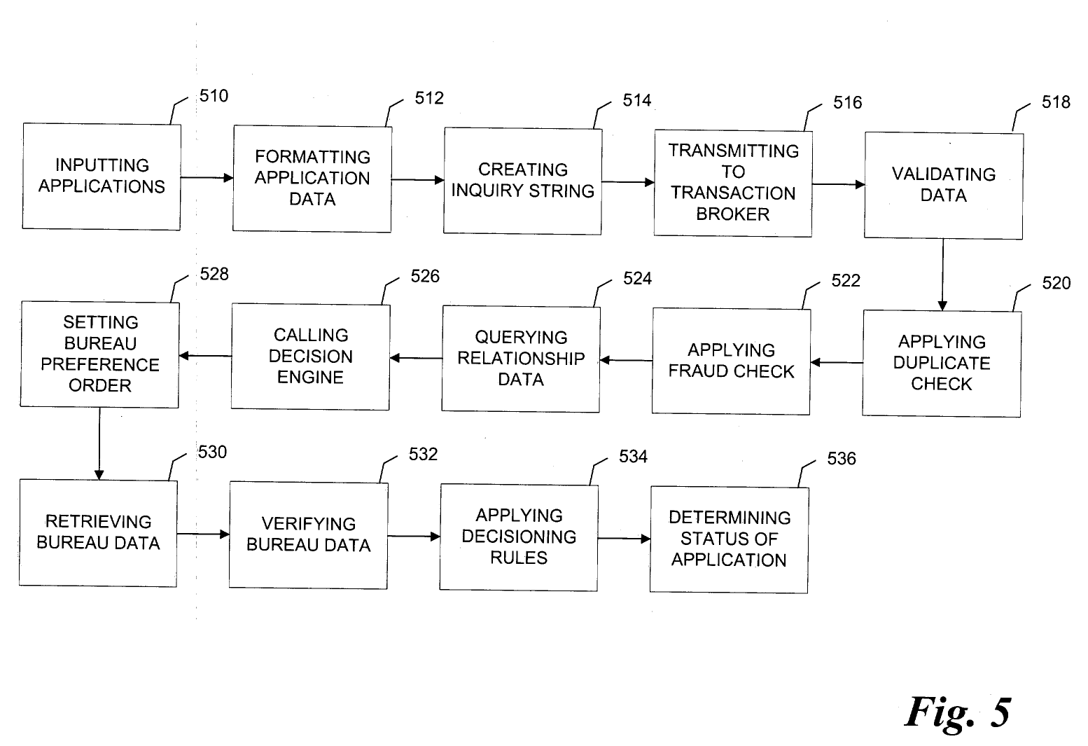

FIG. 5 is a flow diagram illustrating the steps of application processing and checking according to an exemplary embodiment of the present invention. Typically, the loan origination and application process begins with inputting applications 510. Applications may relate to credit card applications, mortgage applications, personal loan applications, automobile loan applications, or any application related to lending institutions. Once the application is received, the system formats the application data 512. Formatting the application data 512, may include error checking, data supplementing, or data manipulation. Using the formatted application data, the system creates an inquiry string 514. The inquiry string provides the system with the appropriate request to process the application. The inquiry string is transmitted 516 to the transaction broker 220. The transaction broker 220 receives the inquiry string and calls a module 316 to validate the data 518. If the data validation 518 proves successful, the application is applied to several checking modules 218. Checking modules 218 may perform a variety of preliminary tests including, but not limited to, checking for duplicates, checking for fraudulent applications, checking whether the applicant is a registered officer, checking whether the applicant is an employee, and checking whether the applicant is a preferred customer. The application is applied to the duplicate check 520. Applying the duplicate check 520, verifies whether the application has already been processed by the system within a set time period. After applying the duplicate check 520, the application is applied to the fraud check 522. Applying the fraud check 522, verifies whether the application is potentially a fraudulent application. After applying the fraud check 522, the system queries for relationship data 524 in the database 222. The relationship data generally relate to the rule sets that are applied by the logic engine 224. Next, the system calls the decision engine 324, 526 to receive the appropriate decisioning rules for the particular application. Likewise, vendor management and configuration may be controlled through the present system to set the bureau preference order 528. The bureau data is retrieved 530 from the corresponding bureaus based on the bureau preference order. Bureau data typically rates the application on a pre-determined grading scale and can be used for risk assessment by decision engines 324. After receiving the bureau data 530, the system verifies the bureau data 532 to determine whether the bureau data retrieval was successful. The system then applies the decisioning rules 534 to the application data and the bureau data. The result of applying the decisioning rules 534 may be used to determine the status of the application 536. For example, the status of the application may include, but is not limited to, approved, disapproved, or pending further review. Steps 528, 530, 532, and 534 are typically performed by the decision engine 324.

In an exemplary embodiment of the present invention, the Application Entry component of the system, part of the user interface 310, may include web screens and system functionality for branch, Internet, and indirect applications. In most configurations, all application information received 510 is stored in the database 222 with a unique Application ID generated for the application. Applications entered into the system 510 may be directed to a decision engine 324 or inserted into the customer's workflow 210. An application may be entered 510 by the branch bank accepting the application, directly by the customer 322 through an Internet application, or indirectly by other origination vendors.

Upon login, a Home screen may appear including a header, a message box to display administrative messages or special deals, and appropriate hyperlinks. The administrative messages are stored in the database 222 and accessed when appropriate. An interface 310 may be provided to the user to add, modify, and delete messages. A table may be added to the database 222 to by-pass the Home screen upon login. Depending on the needs of the user, a different feature may appear as the initial screen.

The system may include a menuing system allowing users to navigate to most screens directly without having to follow a series of hyperlinks. Menu options appear to the user based on the user's permissions and/or preferences. For example, a typical user would not be allowed to access User Administration segments of the system. The menu system utilizes DHTML drop down menus and is customizable. The menu system may allow dynamic additions to the top-most navigation links and submenus. Additionally, a user may change the look and feel of the menuing system, such as the fonts, colors, and font size. The menuing system may support multiple menu levels extending from the base level for submenus. The menu system may be generated from the database 222 or a configuration file.

The system provides several separate search utilities described in more detail below. The searches are embedded within other segments of the system. The separate search utilities may include, but are not limited to, Application Search, Queue Search, and User/Organization Search.

In an exemplary embodiment of the present invention, the Dealer Search feature allows a user to locate dealers for editing. The feature contains a series of independent searchable fields for setting search parameters. Results from the search may include, but are not limited to, the dealer name, contact name, contact phone, state, merchant number, lender name, and status. The results may be sorted on any of the elements returned by the search.

In an exemplary embodiment of the present invention, the Lender Search feature allows a user to locate and modify lenders. The feature contains a series of independent searchable fields for setting search parameters. Results from the search may include, but are not limited to, the lender name, contact name, contact phone, state, and status. Typically, the default order of the results is based on the lender name in ascending order, but the results may be sorted on any of the elements returned by the search.

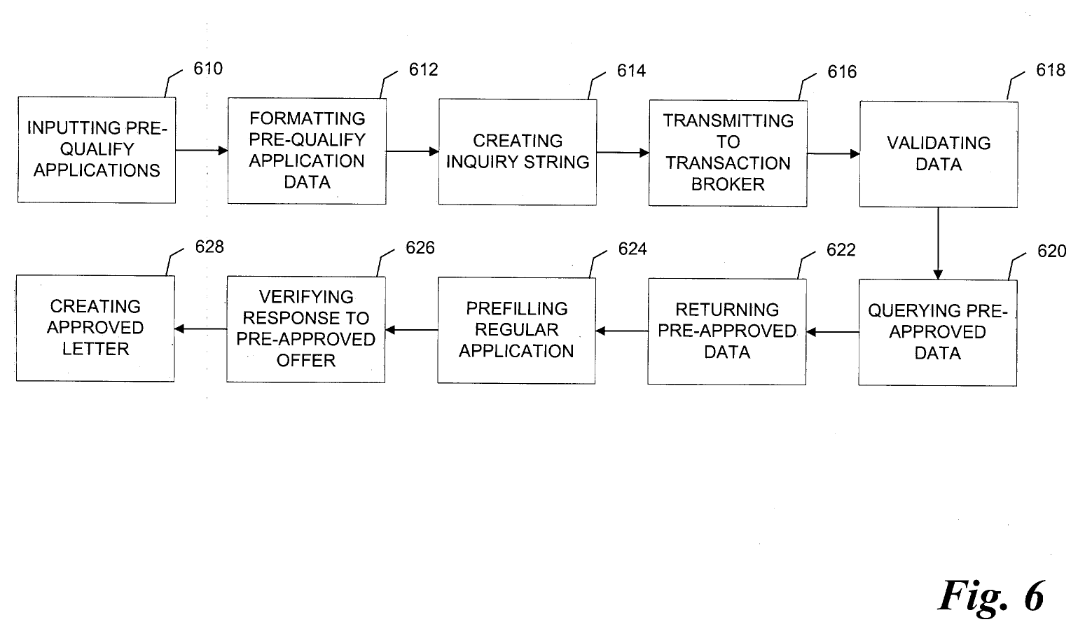

FIG. 6 is a flow diagram illustrating the steps of pre-qualifying application processing according to an exemplary embodiment of the present invention. In addition to processing applications submitted by users, the system may process pre-qualify applications. Pre-qualify applications are used to make a decision to accept an application before the applicant has applied. The system can then produce an approval letter to be sent to the applicant. If the applicant accepts the letter, then a regular application is processed. Pre-qualifying an application begins by inputting the pre-qualify application 610. The pre-qualify application is then formatted 612 to the appropriate layout for the system to process. An inquiry string is created 614 to assist the application process. The inquiry string is transmitted 616 to the transaction broker 220 for processing. Using multiple modules 316, the transaction broker 220 validates the data 618 of the application received. The system queries pre-approved data 620 from the system database 222 and the data is returned 622 to the transaction broker 220 for processing. Once the pre-approved data is received, the system prefills a regular application 624 in anticipation of an applicant's acceptance of the offer. The system then verifies the applicant's response of the pre-approved offer 626. Once the response has been verified, the system creates an approval letter 628 to send to the applicant.

A series of functions may be performed after an application has been entered into the system, but before a credit bureau file has been retrieved and the customer information is processed for decisioning. Duplicate, recent responder, fraud and database checks may be conducted to enhance application processing. For example, in a database check the zip code, area code, and state code from the application may be validated to prevent incomplete or bogus applications from being processed.

In an exemplary embodiment of the present invention, the duplicate application or recent responder check provides the customer with control over application screening frequency. By applying the duplicate check 520, a lending institution may control costs associated with underwriting practices simply by screening out applications that have already been processed within a given time frame. By screening out such applications, the lending institution also mitigates the costs of purchasing duplicate credit bureau files. Applications that have been flagged as a duplicate or recent responder may be sent to a queue for review, to ensure that the application is indeed a duplicate or recent responder. The lending institution may configure the duplicate check at the product or organization level. At the organization level, the check is generally conducted using a defined set of match routines. At the product level, the check is typically configured from a setup screen. The Duplicate Application check allows the organization to configure tasks or actions to invoke when a duplicate application is found in the database table. The user may view attributes of a recent responder application that failed the check by navigating to several screens on the system, such as the Application Summary or Application Review screens. The attributes available for duplicate check may include, but are not limited to, social security number, first name of applicant, last name of applicant, home phone number of applicant, work phone number of applicant, residential address of applicant, drivers license number of applicant, product, channel, organization level, applicant type, address house number, address street direction, address street name, address street type, address city, address state, and address zip code. An exemplary scenario for the duplicate check may include: the user keying in and submitting the application for processing; the transaction broker 220 inserting the record into the consumer table; the transaction broker 220 routing an inquiry to the decision engine 324; creating an XML string, including tags for the application ID, and sending the string to the transaction broker 220; if the duplicate application check is invoked, querying the recent responder table; if a match is found in the responder table, transmitting the result to the transaction broker 220; and querying the workflow table to determine the next task or step to execute in the process defined by the current lender. The lender may send a duplicate application to a queue for manual verification of duplicates.

The administrator may configure a duplicate application check or edit an existing duplicate application check. In an exemplary embodiment of the present invention, the administrator selects Administration-Duplicate Table setup from the menu to administer the duplicate application module. The system presents the Duplicate Application Menu to the administrator, allowing options such as: configure new duplicate check, search duplicate table, and purge duplicate table. The administrator selects configure new duplicate check and the system presents a listing of supported parameters. The administrator may select the parameters and input a numeric value in the duplicate data field. The administrator may apply the duplicate check globally or at the product level. If a product is selected, the system typically prompts the administrator to specify a product ID. The system may validate the product ID against the product table. If the product ID exists and is enabled, the administrator may save the change to the duplicate table. The duplicate application check is generally available for insertion in configured workflows 210.

In an exemplary embodiment of the present invention, the fraud check provides lending institutions with the functionality to identify certain applicants that are not to be accepted. By applying the fraud check 522, the application may be verified against a variety of attributes. If there is a match on all or any of the attributes then the application is flagged, otherwise the application is sent through normal processing. The attributes associated with fraud check may include, but are not limited to, social security number, first name of applicant, last name of applicant, date of birth, residential address, address house number, address street direction, address street name, address street type, address city, address state, and address zip code. In most configurations, each application that is entered into the system may be screened through the fraud check and flagged if a match is found. The fraud check may be a manual or an automated task that may be placed into the loan origination and application processing system at any point during the application process. The system may be configured to reject an application flagged as a fraud or may route the application to a special queue, if desired. Typically, when the fraud search is initiated as an automated task, each consumer application that enters the system triggers a request to the transaction broker 220 for a search. The transaction broker 220 searches the database 222. If a fraud match is found, the application is flagged and may be sent to the fraud queue. Depending on the workflow logic of the particular lending institution, the application process continues. If an application is marked as a fraud, the user may view the application attributes that failed by navigating through system screens, such as the Application Summary or Application Review screens.

In an exemplary embodiment of the present invention, the Registered Officer Check provides lending institutions with the functionality to identify applications of officers of the bank or lending institution. Banks, for example, are required to give special treatment to officers within the bank, because only a limited number of individuals may access this type of information. The attributes available for the Registered Officer Check may be similar to those available for the Duplicate Check.

In an exemplary embodiment of the present invention, the Employee Check provides lending institutions with the functionality to identify applications of employees of the bank or lending institution. The attributes available for the Employee Check may be similar to those available to the Duplicate Check. Database checks may be conducted, for example, to offer employees special rates or to exclude them from the application process. A list of the customer's employees may be loaded into the system. If an application belongs to an employee the application may be flagged similar to that of the fraud check.

Additionally, a lending institution may wish to offer existing customers special rates or other promotional offers. The system may be configured to flag applications from current customers similar to that of the fraud check. In an exemplary embodiment of the present invention, a High Value Customer Check provides a lending institution with the ability to offer special rates and promotions to exceptional customers. The administrator may determine what attributes constitute a high value customer.

In an exemplary embodiment of the present invention, the process allows for several methods of lender selection that are configurable by an administrator on the system. Once the application has been completed and submitted through a web interface 310, for example, the application data may be sent to the transaction broker 220 in XML format and the data elements may be inserted into the database 222. Once a successful bureau pull is performed, the file may run against the lender's criteria.

Any of the above checks may trigger on the matching of all or some of the attributes associated with the application. By flagging an application for a match on some of the attributes, the checks may support hierarchical queries.

The loan origination and application processing system may be configured to access the appropriate bureau depending on application data. For example, the most common preference setting is by the applicant's zip code. The system may specify which of the various bureaus are to be used for the incoming applications so that the system may automatically retrieve the credit file.

In an exemplary embodiment of the present invention, the transaction broker 220 may format data in the proper file format for the auto-decisioning object. The application data may then be converted to the valid credit-bureau-inquiry format before moving through the transaction broker 220 to the decision engine 324, 526. Typically for internet applications, the database 222 is updated immediately and the applications are automatically routed to the decision engine 324 for auto-decisioning 534. Indirect applications generated by outside originators may be provided to the system, preferably in XML strings, that are then mapped to the appropriate database fields, and then sent by the transaction broker 220 to the decision engine 324. Additionally, the loan origination and application processing system manipulates generic XML inquiries. Depending on the decision engine 324, certain pre-defined vendor calls and email notifications may be generated automatically. Applications meeting pre-specified criteria may be flagged for automatic insertion into the workflow 210.

Generally, auto-decisioning responses return to the system environment in a particular file format. Notification may be by facsimile, over a secure internet connection, or over a dedicated line to the system. Depending on the criteria and the specific decision engine 324, the responses may include, but are not limited to, Pass, Fail, and Pending. In determing the status of the application 536, if the application meets all of the decisioning criteria, the response is Pass. If the application fails the decisioning criteria, the response is Fail. If the decision logic does not result in a decision, the response is Pending.

For some Pending applications that require valuation or insurance, for example, the vendor module may automatically generate vendor requests. These requests may execute from within the system or may be conducted directly following auto-decisioning, before the application passes back to the system. Depending on the vendor, requests may be made for Pass decisions, and the response may require re-decisioning of the application.

Many applications that enter the loan origination and application processing system may require some level of processing and manual review. In an exemplary embodiment of the present invention, applications may be routed into the Application Review section automatically, or movement may be driven by the workflow process. Usually, applications enter the Application Review section because, after auto-decisioning, the application was flagged for review. Alternatively, the application may enter the Application Review section because the customer does not employ auto-decisioning and, therefore, all incoming applications must be manually reviewed before a decision can be determined. The Application Review features allow users to perform necessary processing functions, including, but not limited to, verification, offer/counter-offer procedures, application updates, collateral review, payment calculators, and rendering of a final decision. The Application Processing and Review section may include, but is not limited to, application search, application summary, applicant summary, edit application, bureau data review, collateral review, decision review, calculations, and event and note logging.

In an exemplary embodiment of the present invention, the Application Search component allows the user to search for existing applications. The basic specifications for this tool generally match those of other system search tools. The Application Summary component displays application information for user reference. A link to the Edit Application feature displays the same information, but in an editable form. The Application Summary feature is useful for restricting users to read-only privileges. The Applicant Summary component may display additional data for each applicant on the selected application. The Application Summary screen is read-only. Additionally, the Edit Application component provides application and applicant data in an editable form. Changes entered by the user are automatically updated in the database 222. Additionally, users may re-submit an application for re-decisioning or re-processing from the Edit Application screen. The loan origination and application processing system may be configured to automatically re-submit the application based on the changes made with the Edit Application feature. The Bureau Data Review component displays the actual credit bureau report returned to the system from the decision engine 324 or bureau interface. Generally, all designated credit file attributes and their respective values come in an HTML bundle and are displayed onscreen for viewing. Certain users, with appropriate permissions, may view these attributes and evaluate the values when rendering a manual decision. Also, additional bureau reports may be accessed through this component, if necessary, to make a decision. The Collateral Review component provides a listing of collateral associated with the application for viewing and editing. Collateral may include, but is not limited to, automobiles, boats, real estate, or financial assets. Vendor orders such as an appraisal, title, and valuation may be conducted using the Collateral Review feature. Additionally, the Decision Review component displays all of the decisions made during application processing and allows users, with proper permissions, to render decisions. A series of fields and tables may be provided to accommodate decline codes and to stipulate decision notification and adverse action letter parameters. The Calculations component provides the ability to calculate payment, insurance and other calculations during the application review process. The Event and Note Logging component provides all of the major actions that occur during application processing. Typically, these events are recorded in the Event Log and may include the date/time stamp, application ID, username of person causing the event, and an event description. Qualifying events may be defined by the administrator prior to installation of the system.

In an exemplary embodiment of the present invention, the loan origination and application processing system provides a series of calculation tools allowing the user to enter values and receive outcomes based on those values. The calculation tools are generally used for making payment calculations and are based on pre-coded logic, but may be used for other determinations as well, such as insurance calculators. Additionally, custom calculators may be developed to accommodate additional calculation requirements.

In an exemplary embodiment of the present invention, the logic engine 224 automatically coordinates the movements of applications through the system. Such automatic coordination may be referred to throughout the present description as the system workflow 210. Applications entered into the system are placed into work containers called queues. The queues are arranged in a logical processing sequence and define the individual tasks to be performed on each application. Users may access queues based on permission levels. Generally, when a user works applications from queue to queue using the task lists provided, the user is in the “workflow mode.” Workflow 210 describes the overriding structure and sequence of loan processing in the system. Workflow 210 begins when an application enters the system and does not complete until the application gets booked and leaves the system. Generally tied to a product, workflows 210 allow applications to move through the system based on types that may include, but are not limited to, loan type, organization type, or product request type. Typically, administrators are responsible for establishing the appropriate workflow 210 within the system, while other users perform the majority of loan processing duties within the bounds of the system workflow 210. The administrator may designate an initial queue assignment scheme called the “pre-workflow process”, which sets the workflow parameters for incoming applications.

In an exemplary embodiment of the present invention, the loan origination and application processing system workflow 210 is built on three levels. The top level is the workflow 210 itself, which is usually based on a product type. A product is the good or service being applied for by the applicant. Basically, a workflow 210 is a hierarchical task list that organizes, in sequence, all the operational functions required for a given type of application. The second level of the workflow 210 is comprised of queues that define the major categories of the workflow 210. Applications may reside in multiple queues simultaneously and queues may exist inside of other queues. The third level of the workflow 210 comprises tasks that include individual actions or activities to be performed within each queue. Depending on the workflow parameters, multiple tasks may sometimes be performed simultaneously. The system automates the workflow 210 and organizes all of the tasks sequentially while driving the application forward in the sequence as individual tasks are completed.

In an exemplary embodiment of the present invention, each task is a singular unit of work defined by a row in the task table located in the system database 222. Typically, there are three types of tasks: manual, automatic, and external. Manual tasks are performed by the user. In most configurations, the workflow 210 guides the user by giving short descriptions of the task to be completed. Task execution is typically controlled by the logic engine 224. Alternatively, manual tasks may be recast as an automatic task which is one initiated by the system when it becomes the next task to be completed. An external task waits on an external process to complete before it proceeds through the workflow 210. This type of process is often used with a waiting queue while an appraisal or title order is pending. Typically, once the external process has completed the system checks the task as complete. At the completion of a task a process may mark the current task as complete in the database 222 and determine what task, queue, or workflow 210 the application should be routed to next. A database flag determines whether the current task needs to have an application note submitted in order for it to continue through the workflow 210. Application notes provide the system with specific information concerning the processing of a particular task. Additionally, the system provides a display method to instruct the user when an automated, rather than manual, task is going to occur. Typically, the display information informs the user on what the next task might be.

In an exemplary embodiment of the present invention, queues are the containers for tasks and are defined by a row in the queue table located in the database 222. Generally, a queue is a collection of one or more tasks put together in a logical order. Queues define the location of an application in the workflow 210. Queues may be dependent and/or parallel. In a typical configuration, dependent queues cannot be completed until the previous queue has completed. Parallel queues may be completed simultaneously. Dependent and parallel queues are children queues of the queues that come before them in the workflow 210.

In an exemplary embodiment of the present invention, workflow 210 is the container for queues and is defined by a row in the workflow table located in the database 222. Workflows 210 may be standard or system workflows. Standard workflows are used to process applications while system workflows are used to manage the process of administering the platform.

In an exemplary embodiment of the present invention, the current invention uses a parent-child hierarchy to establish the proper sequence within each workflow 210. The parent-child hierarchy may be used to create subordinate levels among tasks and queues. The top-level parent is the workflow 210 itself, from which all child queues descend.

Typically, applications are routed through the workflow 210 according to rule sets created by the administrator. A rule set consists of a number of different parameters related to an application in the system. An administrator may define a rule set with appropriate values for each parameter. Once a rule set is created it may be used to control routing of an application through the workflow 210.

Additionally, rule sets may be associated with any task in the workflow 210. If the application being processed matches the rule set for the given task, the task may be skipped. Generally, this process is called conditional pre-routing. Conditional pre-routing may aid in speeding up applications through the workflow 210.

In an exemplary embodiment of the present invention, the system supports workflows 210 allowing applications to automatically route to any available task within the current queue or to any queue. Referred to as automated conditional post-routing, this process may be accomplished at the completion of a task based on a rule set. Additionally, an administrator may define a rule that will determine where an application will be routed. Generally, manual conditional post-routing questions are associated with a task and provide possible answers for the user to select. Based on a manual selection of the answer, the application may be routed to the corresponding task or queue. Additionally, the workflow 210 may route an application back to a previously worked queue when necessary for re-processing. Routing back may be accomplished with the system's application queue routing stack. The stack keeps a record of the queues the application has been through and, therefore, assists in routing an application back to a previously processed queue. Routing an application back to a previously processed queue may be necessary if the application changes or is updated during processing. Such changes or updates may warrant the application being reprocessed through the workflow 210.

Additionally, to prevent applications from becoming lost in the loan origination and application processing system, a queue reroute function is employed. If an application sits unprocessed for a predetermined length of time, it may be automatically rerouted to another queue in the workflow 210. The usual reroute location is the queue immediately preceding the one containing the dormant application; however, any queue in the system may be designated as the rerouting queue. The administrator establishes reroute times and locations during system set-up.

Sorting the queue order may be accomplished in a variety of ways. Similar to rule sets, the administrator may set up different sorting schemes based on a set of parameters. The parameters may be organized in a tiered approach, with the first parameter being the primary sort definition. The second may break any ties of the first parameter and so on.

For added flexibility within the workflow 210, risk level and referral source may be used to exclude tasks and queues based on the origin and security risk of the loan application. Queues may be set up to receive only applications from a specific source and assigned a specific risk level. Tasks are not applicable to certain risk levels and referral sources may not display when the queue is opened. Tasks and queues are assigned risk levels and referral sources when the system is installed.

In an exemplary embodiment of the present invention, queues may be of the push or pull queue type. Push queue type means that a typical user may be pushed to the next application based on the queue sort order, which is configurable by the end user. Some users may have the ability to override the queue type and have a push queue treated as a pull queue. A pull queue type means that a typical user may be shown a list of the available applications in the queue arranged by queue sort order. The user may pull the application desired, instead of receiving the application pushed from the queue. Additionally, the workflow 210 supports the ability to prioritize the applications within the push and pull queues. Prioritization criteria may be determined and applied to all queues within the workflow 210.

In an exemplary embodiment of the present invention, users that access the workflow 210 may be grouped together by job function as well as in teams. The loan origination and application processing system provides an interface 310 to the users to participate in the workflow 210. A floating task checklist may be provided to a user working an application through a queue in workflow mode. The floating task checklist may include, but is not limited to, a graphical representation of the tasks in the current queue; all tasks that can currently be completed have checkboxes for the user to mark as complete; tasks that have been completed are grayed out with check marks next to them; tasks that are not yet eligible to be completed are grayed out; and hyperlinks to screens that may be helpful to the user in completing the tasks within the queue. The floating task checklist may be moved anywhere the user wants it within the browser window. Initially the floating task checklist scrolls with the browser window, but the user has the option to “tack” it down on the screen. When tacked down, the floating task checklist stays in the same place relative to the screen and is not affected by the user scrolling the page in the browser. Generally, when the user is no longer in an application the floating task checklist is not displayed.

In an exemplary embodiment of the present invention, the loan origination and application processing system provides a sidebar available to a user via the screen and may include a button to select if one wants to be in workflow mode. If the user chooses workflow mode, the sidebar displays the queues that the user has permission to work. Each of the queues in the sidebar may be a link. If the queue is a pull type, an icon to the right of the name of the queue may appear. If the user clicks on the icon, the main browser feature may provide the queue search results feature with multiple applications listed. If the queue is set to a pull type queue, the sidebar displays the list of several applications in the queue. The list is sorted by a predefined set of parameters and shows only the primary applicants name and the application ID. The user may then select an application to work by clicking on the provided link. The user may be directed to the screen associated with the first task to be completed. If the queue is a push type queue, the regular screen displays the application feature associated with the first task in the queue based on the sort-order of the queue. If no feature is associated with the first task, the user may be directed to the Application Review feature. Also, the workflow 210 may be displayed in the floating task checklist window.

Generally, a user may start working in workflow mode by choosing from the menu or the sidebar. The system provides a Search Menu with a My Queues menu option. If the My Queues menu option is selected, the user may be directed to a web page which lists all the queues of which the user has permission to work. Similar to the sidebar process, the user then selects a queue. The queue type determines if either multiple results are displayed in the queue search results page or if the first application is automatically provided. Additionally, the system provides the user with the ability to check-out an application, preventing other users to work on the application. An application is considered checked-out when the user selects the application for processing. When checked-out, the system may update the database 222 with the user ID and the date and time the application was accessed. During the checked-out period, other users may not be able to work on the application, but may be able to view the application and associated review screens. Checked-out applications may not show on the workflow applications select list. Once the application is processed and sent back to the workflow 210, the application is considered checked-in. Also, if the user attempts to log off of the system, the user is provided a list of any applications that have been checked-out. The user may check-in an application at this time or keep the document checked-out. Later, when the user logs back in, a list of applications checked-out may be presented again. The system regulates all of the checked-out documents and may allow an application to be checked-out for a certain time period before checking the application back into the workflow 210.

Typically, when the user has finished all tasks associated with a queue, the application automatically routes to the next available non-empty queue or queues. If the user has permission to work any of these queues, the user may be prompted in the floating task checklist as to whether he or she wants to follow the application into the next queue. If the user indicates affirmatively, the floating task checklist displays the tasks associated with the new queue. Otherwise, the screen displays either the queue search results screen or the next application in the queue based on the queue type.

In an exemplary embodiment of the present invention, the loan origination and application processing system provides a workflow administration tool designed to allow administrators to create workflows 210, queues, and tasks. Workflows 210 generally follow a logical processing sequence. For example, one simple workflow sequence order may be: fraud queue, duplicate queue, pass queue, decline queue, review queue, closing and document preparation queue, and done queue. Alternatively, the workflow sequence may be altered to facilitate the customer's processing needs. Administrators may modify current workflows 210, queues, or tasks. Once a workflow 210 is added to the system or an existing workflow 210 is accessed for modification, queues may be added or modified. Typically, a screen appears with a drop-down list of existing queues, and users may select queues from the list and add them to the workflow 210. In order to designate the proper queuing sequence, the user may designate the “parent” queue for each queue being added to the workflow 210. Initially, the workflow 210 is the only possible parent option, but as queues are added to the workflow 210 they become parent options. Each level-one child of the root workflow 210 is called a “node.” Clicking on a node allows the user to modify the node, delete the node, or employ conditional routing and other custom workflow features. Queues may be added and modified in the same manner as workflows 210. Typically, all automatic tasks are defined prior to system install. Alternatively, additional automatic and manual tasks may be added as needed. Additionally, all automatic tasks may be defined prior to system install, but manual tasks may be added as necessary.

In an exemplary embodiment of the present invention, a logic engine 224 is provided to apply processing rules and to trigger actions to be performed in accordance with the rules. The logic engine 224 functionality is typically incorporated into the system workflow and operates in cooperation with the transaction broker 220 to process logic decisions.

The logic engine 224 allows a user to set the parameters for all logic-driven processing functions within the system. The logic engine 224 may accommodate all possible conditions and scenarios while allowing functions to occur automatically. Using the logic engine 224, administrators may define the basic rules for any logical, condition-dependent process; configure and modify the logic applied at each process level; and establish actions to be performed based on the results of a logical inquiry. The actions triggered from the logic engine 224 may be performed at any point in the logic path.

Additionally, the logic engine 224 provides mutually exclusive functionality that can process requests and determine appropriate outcomes. The logic engine 224 is preferably user-configurable so that administrators may use pre-determined attributes to define logic rules and determine desired outcomes. The logic engine 224 may be configured to distribute a workload across multiple servers and may process multiple requests in parallel.

The logic engine 224 utilizes database tables. Generally, the logic rules recompile if changes occur in the specific database tables. Recompiling the logic rules may be accomplished manually by a programmer or automatically with software initiated by the system user. The logic engine 224 utilizes the database 222 to access consumer application information, the definitions of the logic rules, and/or application processing conditions. The consumer application information is evaluated against the logic rules to determine whether any actions need to be performed to reach a certain outcome. The logic rules and application processing conditions allow the logic engine 224 to apply logic and conditions to the applications for processing.

Generally, every logical structure in the logic engine 224 starts with a process. The process is an overall logical sequence, defined by a name and its corresponding objects. The objects may be rule sets or actions. Rule sets consist of one or more individual rules, that use pre-defined attributes and contain a logical statement that may have a Boolean evaluation. Actions allow the performance of application processing functions within the system based on the Boolean logic. The logical path is determined by assigning positions to each process object.

Attributes are typically created by programmers, because of the database knowledge required for setup. Attributes are any piece of data necessary for proper logic including, but not limited to, application information. Attributes may be given a name and description for easy identification during rule configuration. The attributes are defined using numeric or alphanumeric data structures that ensure proper syntax during operation.

The rules are logical statements that assign values to attributes and make true or false determinations. Attribute values may be defined using common operators such as equal, less than, greater than, less than or equal to, greater than or equal to, and not equal.

Usually, rule sets define the relationship between component rules. A rule set is made up of one or more rules which can be evaluated as true or false. The relationship between the rules may include, but is not limited to, if any, if all, if none, if exactly one, and if all but one. The same rule set generally cannot be used for two distinct conditions, because relationships are part of rule set definitions. New rule sets may use the same rules, but create different relationships.

Actions are code that perform a particular function. Actions are defined by the specific function executed and the location of the action in the logic path. In most configurations, all actions have names and descriptions for easy identification. By setting maximum time-outs, actions may be re-started automatically. For a function being called to operate successfully, the action may contain the appropriate parameters necessary for the function. It is not unlikely for every action in the system to have a unique parameter list.

In an exemplary embodiment of the present invention, every process object contains a position field. The position field identifies the object in relation to other objects. The logic path may be determined by giving each object a position number and assigning the positions Boolean outcomes. An assignment of a rule set may result in the logic proceeding towards the Boolean outcome for that rule set. If the association is an action, the action begins automatically. Processes are created by combining the assigning positions with the objects.

Typically, an administrator may create a rule set by defining rules using attributes already supplied by the system and combining one or more rules into a rule set. Actions may be created by defining the action and defining the parameters necessary for the functions to operate successfully. Processes may be created by the administrator by naming the processes and combining one or more rule sets and one or more actions as process objects.

Whenever any aspect of the workflow is updated or removed from the web screens, the logic engine 224 is notified. Such modification triggers the transaction broker 220 to notify the logic engine 224 of the change. The notification may be accomplished through an XML request to the logic engine 224. With the notification, the logic engine 224 ensures that an application does not find itself stuck in a queue that is no longer part of the workflow. In a typical configuration, queues should be cleared before being removed from the workflow.

In an exemplary embodiment of the present invention, the loan origination and application processing system provides utility to organize the system into distinct user groups. For example, the user groups may be represented by bank branch, region, or other logical category. The workgroup component is incorporated with the user and organization object and allows individual processing restrictions to be applied to groups of users. Additionally screen permissions and user roles may be established to create specific restrictions for each user. The user management and organization management tool allows administrators to define specific organizations, assign users to those organizations, and manage user profiles.

In an exemplary embodiment of the present invention, organization functionality is defined through database tables that allow a great deal of flexibility in creating organizations and setting up the relationships between them. Typically, the database 222 contains a number of fields that represent an organization. The fields are defined by look-up tables that break the organization down to a detailed level. Organizations may be assigned to parent organizations and there is no limit to the number of children of a parent organization. For example, the organization record may be created to represent the corporation, then a child organization may be created to represent the business unit, and the children of the business unit may be created to represent specific branches, dealers, vendors, or brokers. Only a parent organization may see its users and the users of its children, therefore, assisting in management.

In an exemplary embodiment of the present invention, the database design also supports configuration for users. With users, it is not necessary that all of the fields be utilized. Certain fields may be required, however, such as the permission group ID.

Additionally, the system provides a User Administration segment that provides the functionality for administrators to find and modify specific organizations. Although the user-organization structure is initialized prior to installing the system, administrators may add and modify organizations and users any time after installation. Organizations include, but are not limited to, bank branches, departments, or any other user category the administrator desires. The User Administration segment allows users to add subgroups to the main organizations and add individual users to each of the subgroups. Organizations and users may also be deleted from the system by the administrator. Additionally, users, subgroups, and organizations may be designated active or inactive.

Using the Organization Setup component, the administrator may access the Add Organization and Modify Organization features to check for the presence of a valid organization ID. If a valid organization ID is found, the Modify Organization screen may be populated with the corresponding organization information. Otherwise, the screen is left blank for the administrator to add a new organization.

To assist in User Administration activities, the system provides a User Search feature that allows administrators to search for a present user or add a new user. Search results are displayed in the same manner as the Application Search results, with the default sort being alphabetic on last name or organization name in ascending order.

The Organization Search feature includes a number of fields in which the administrator may set search and sort parameters. If the administrator selects an organization to add users, the system redirects the administrator to the Add User screen for the selected organization. The User Search may also include fields for the administrator to set and sort parameters according to specific user information. The administrator may modify a user by selecting a user in the result list. The system may redirect the administrator to the Modify User screen for the selected user.

Generally, adding and modifying users utilize web pages combined with the workflow. Typically, every user in the system has a user profile. The profile identifies each user in the system, records personal information, assigns usernames and passwords, and sets additional access and organizational parameters. All users may be assigned a user profile according to the organization, designated workgroup, and the user role or a specific set of permissions. Typically, certain fields may be unique, such as the user's social security number and user login name. If the administrator selects a social security number or user login name that is already in use, the system may notify the administrator that a new number or login name is required.

When an administrator adds a new user, a blank form to enter user information is presented. The blank form provides all the relevant information necessary to create a new user. When an administrator modifies a user, the administrator is presented with a screen to search for the user. Once an administrator selects the user to modify, a form similar to the blank form presented for adding a user will be provided. However, the form for modifying a user will be pre-populated with correlating information about the user. The Modify User screen also provides the administrator with the ability to enable or disable a user, by use of an active flag.

In an exemplary embodiment of the present invention, administrators may assign users to specific workgroups. For example, one department in a company may work home equity loans, while another works credit card applications. The supervisor may access all products in the system, while limiting access to other users. Each workgroup usually contains typical users and group administrators. Typical users are limited to certain functionality for working in the workgroup, while administrators may add and delete users from certain workgroups. The Workgroup Management feature is accessed from the Main Menu. Administrators may choose among all available users from a selection tool at the bottom of the screen. The administrator may then add and remove users from a workgroup using the selection tool.

In an exemplary embodiment of the present invention, a permission schema is created in the system to restrict access to certain screens. Permission groups may be designated to access particular screens, thus limiting users to specific screens and specific operational functions based on the user's group designation. For example, a typical user permission group would only have access to screens which perform basic loan processing functions. An underwriter permission group, however, may access additional loan officer functions such as payment calculators, decision notification, and debt worksheets.

To establish permission groups, the administrator designates which screens to include in the permissions platform. The screens are then ordered into logical screen groups. The permission groups may then be created using the screen groups to define overall access parameters.

In an exemplary embodiment of the present invention, administrators may also set up lenders in the system. Lenders underwrite the programs and promotions available to the dealers. The Lender Search feature enables the administrator to search for existing lenders to modify. Also, the administrator may add a new lender to the system. By entering the Lender Setup component from the Main Menu, the administrator may be directed to the Add Lender or Modify Lender screens to check for the presence of a lender ID. If the lender ID exists, a pre-populated Add Lender screen is presented, otherwise the screen fields are left blank. The administrator is presented with a blank form to enter lender information when adding a new lender. The information may be saved to the database 222 after validation. When modifying a lender, the administrator searches for the specific lender to modify. If the lender exists, the administrator is presented with a screen with pre-populated fields for the administrator to change. After modification, the administrator may save the changes to the database 222 after validation. If the information submitted is not valid the administrator is returned to the modification screen to correct the information.

In an exemplary embodiment of the present invention, administrators may set up dealers on the system. Dealers are generally organizations that “sell” loan products on behalf of a lender. Dealers have relationships with lenders to subscribe to the programs and promotions offered by the lenders. When a new dealer is added to the system, the administrator provides the primary dealer contact information, lender relationship information, and vendor relationships. The Dealer Search screen permits the administrator to search for existing lenders to view or modify. To add a dealer, the administrator is directed to the Dealer Application screen. After filling out the general dealer information, the administrator is directed to the Lender Relationships screen. This screen provides a drop-down list of active lenders for the administrator to select a lender to setup a relationship. After setting up the relationship, the administrator is directed to the Vendor Application screen where a list of required fields for the vendor will be displayed. After this information has been entered, the administrator is directed to the Vendor Relationship screen to setup the vendor relationships.

The Lender Relationship feature provides a drop-down list to select a lender to add to the dealer profile. A list for the currently related lenders may be displayed to enable the administrator to modify lender-dealer relationships. The Vendor Relationship screen displays vender information under each heading, with the name of the vendor being a link to the Modify Vendor screen. If no vendors exist, the fields on the screen are left blank. An Add Vendor link appears next to each vendor type for adding vendors. Once a vendor has been selected or added, the relationship information will be updated.

Generally, the loan origination and application processing system provides flexibility for the user of products. The system accommodates many product scenarios, therefore, it is unnecessary to predict every possible product that could be used by a financial institution. In an exemplary embodiment of the present invention, the system allows the administrator to create products, promotions, and set up cross-selling, down-selling, and up-selling relationships. During initial installation, a product platform is defined, but administrators may add, modify, and delete products at any time. Additionally, promotions may be added to the products. A typical user does not have access to any of the functionality associated with products. Instead, a typical user selects a product from a list that is available in a drop-down list during application entry. Administrators, however, have access to all product management features.

In an exemplary embodiment of the present invention, the administrator begins by conducting a product search from the Product Search screen. The screen allows an administrator to add a new product or search for an existing one. If the administrator decides to undergo product management, a series of screens allow the administrator to create, modify, and delete products. Products are originally defined at the base level, with a series of attributes applied to the product. The attributes are chosen using multiple select lists, where left and right arrow buttons allow inclusion or exclusion of the attribute. The Product Administration component allows the administrator to create products, called programs by some financial institutions, from a configuration of static lookup values stored in the database 222. Typically, the static data cannot be changed by the user. Administrators access this segment by selecting either Add or Modify Product from the Main Menu. Like adding and modifying users, the screen fields are blank when an administrator adds a product and the fields are pre-populated when an administrator modifies a product. If an administrator tries to add a product that already exists, a validation message appears asking the administrator to either choose a new product number or cancel the action. Duplicate product information may not be inserted into the database 222. Once a product is added to the database 222, the stored product attributes automatically populate the corresponding drop-down boxes. If the administrator decides to modify a product, the system directs the administrator to the Product List screen which displays all existing products. The products may be listed by name, tier, description, and status, while sorted in ascending order by name. The administrator may click on a product and may be directed to the Modify Product screen where the fields will be pre-populated. After modifying the product, the administrator may save the changes into the database 222.

In addition to product management, the loan origination and application processing system provides a series of Promotion Management screens to allow administrative users to create, modify, and delete promotions. Usually, promotions are first defined at the base level with a series of attributes applied later. The Program Administration component allows administrators to create promotions from a configuration of static lookup values stored in the database 222. The static data generally cannot be changed by the typical user. Administrators access the static data by selecting either Add or Modify Promotion from the Main Menu. Like adding and modifying users, the screen fields are blank when adding a promotion and the screen fields are populated when modifying a promotion. If an administrator attempts to add an already existing promotion, a validation message appears asking the administrator to choose a new promotion number or cancel the action. Typically, duplicate promotion information may not be inserted into the database 222. Once a product is added to the database 222, the new information is automatically populated into the corresponding drop-down boxes. The administrator adds a new promotion to change the contents in the drop-down boxes. If an administrator wishes to modify a promotion, the system may direct the administrator to the Promotion List screen, which may display all existing promotions listed by name, number, short description, product, collateral, promotion rate, start date, end date, and status. The administrator may click on a promotion and the system may direct the administrator to the Modify Promotion screen that is pre-populated with the information pertaining to the selected promotion. After modifying the information, the administrator may save the information into the database 222.

Generally, a non-editable promotion list is available to all users. This list allows users to view the promotions available to them as they enter applications on the system. The list may include, but is not limited to, the name, number, short description, program, collateral, promotional rate, start date, and end date of the promotion. When a user clicks on an individual promotion in the Promotion List screen, the user is directed to the Promotion Display screen.

In an exemplary embodiment of the present invention, the system provides the administrator with the functionality to create relationships between products and promotions. The administrator may select the Product Administration feature from the Main Menu. The feature displays a list of products allowing the administrator to establish relationships. The administrator chooses the product from a drop-down menu. The system provides a second drop-down menu that contains all the promotions currently related to the product. The administrator may choose the product-promotion pair to set up a relationship. The product and promotion pairing may be moved to several categories including, but not limited to, cross-selling, down-selling, and up-selling. After setting up the relationship, the administrator may save the information into the database 222. The administrator may also remove a product-promotion from a category at any time.

In an exemplary embodiment of the present invention, the loan origination and application processing system provides automated rate calculation functionality that assigns a variable rate structure to every product in the system. Generally, product pricing begins with a base rate, and then a series of attributes, or rate adjustments, are applied. Attributes may include, but are not limited to, loan amount, term risk level, geographical areas, and PTI or DTI calculations. The attribute values may be absolute, relative, or a percentage. Additionally, the system accommodates rate structures of varying complexity.

Generally, during initial installation of the system, attribute types are pre-defined. Attribute types may include, but are not limited to, application data (term, source channel, loan amount, and income), credit bureau data (score, debt-to-income ratio, and number of derogatory items), or data calculated by the bank or financial institution (loan-to-value ratio, risk level, and payment-to-income ratio). Additional attributes may be defined with Yes/No flags. For example, a financial institution might give a discount rate to consumers with existing bank relationships. The attributes allow for private and group rate adjustments.

In an exemplary embodiment of the present invention, base rates begin with a starting numerical value that may be subject to a margin amount or percentage. For example, a standard four points may be added to the prime rate allowing the base rate to fluctuate in tune with market conditions and lending policies before attribute values are applied. Base rates may also vary by state, lien item, source channel, and risk level. Consequently, administrators may minimize the amount of base rates and attribute values in use. Each rate structure may also be subject to absolute minimums and maximums as defined by the administrator.

The typical user does not have access to the system rate structure. Usually, all application and consumer data passes through the rate parameters automatically and the payment calculator is pre-populated with the appropriate product rate. If a rate override capacity is used, additional rate adjustments may be made by loan processors. All base rates and attribute values are defined by the administrator.

Additionally, administrators may modify existing rate structures and create new rate structures. Base rates and corresponding attributes are initially setup during installation. Base rates and their associated applied attributes are typically called rate calculation methods. In most configurations, every product has its own rate calculation method. The administrator may change attribute values, add attributes to the base rate, or remove attributes. The administrator selects either Add or Modify Rates from the Main Menu to access the rate administration segment of the system. The Add and Modify screens work similar to that of adding and modifying a user as described above.

The administrator may be prompted to create a rate tree or modify an existing one after the initial parameters have been defined or adjusted. Rate trees start with the base rate and are then subject to branches or attributes. Branches may extend to multiple levels. Administrators may define: the number of ranges for the attribute, the actual values for each range, adjustments to the base rate for each range, and whether the adjustment is absolute or relative for each branch. After all the ranges and values have been defined, the administrator may save the rate calculation method into the database 222. After the update, all incoming applications for the rate's associated product pass through the new rate parameters.

In an exemplary embodiment of the present invention, the loan origination and application processing system provides automated vendor services. Through pre-configured interfaces, the system provides access to the industry's most common data sources, outside originators, document engines 226, decision engines 324, and booking/servicing agents. The transaction broker 220 maintains the interfaces so that the system may request and receive vendor data, send acknowledgements, parse through data, and perform necessary database modifications. The system also provides automatic product orders and vendor faxes, that are set up as automated tasks within the workflow object. Using the vendor screens, users may manually order vendor products and track order status. Also, system users may add, modify, and delete vendors provided that the vendors have existing connections to the system.

The vendors/data sources object includes vendors with existing connections to the system. New connections are managed separately, using custom-built vendor interfaces. Generally, interfaces cannot be created, modified, or deleted without a formal customer request and the appropriate technical specifications. Fax and email requests, however, may be supported by any vendor, even if there is no existing connection.

In an exemplary embodiment of the present invention, the system provides a Vendor Search screen to begin Vendor Administration activities. The screen allows administrators to add a new vendor or search for an existing vendor. The Internal Vendor Administration screen allows the administrator to add or modify information about the vendor. Upon submitting the information about a vendor, a validation is conducted for the submitted data. If any of the data is not valid, the administrator is notified of the failure. If the data is valid, the information is saved and the administrator is directed to the Vendor Summary screen.

Additionally, administrators may add, modify, and delete external data sources according to the specific needs of the lending institution. A vendor profile is created for every data source added to the system. Profiles are organized by category, with several fields existing for each category. The fields may be edited by users with the appropriate privileges.

The Vendor Summary screen contains headers for each type of vendor. The vendor information is displayed in each header and a link exists for vendor modification. A link appears next to each vendor type to add vendors. Clicking on each vendor name navigates the administrator to the Modify Vendor feature for the particular vendor selected. After a vendor is modified or a new vendor added, the relationship information is updated.

Typically, every time the system receives valid data transfer from a vendor, a transaction fee is charged for the service. In an exemplary embodiment of the present invention, the Vendor Invoicing function allows administrators to track, reconcile, and update vendor invoices. Using the Vendor Search Results feature, an administrator may choose a vendor to access the Vendor Information screen. The Vendor Information feature displays a link to access the invoice for the particular vendor selected. The administrator may conduct an invoice search for each particular vendor.

In an exemplary embodiment of the present invention, the loan origination and application processing system is in communication with a document-production engine 226. The document production engine 226 allows automatic printing of nationally-compliant documents for approved loan applications. Document templates defined by the user may be created for each product type and include the necessary data fields. The fields are mapped to the database 222, allowing automatic population of application information. The Document Fulfillment feature allows third-party letter generation, used for adverse action letters and other consumer notification forms.

Document Fulfillment typically is part of the closing process. Multiple standard document-printing screens allow the user to print the appropriate documents for the given loan application. Documents may vary based on the product and state involved. Users may be presented with all documents in the system, or only those pertaining to the given application type. Dealers usually print the majority of documents; therefore, document preparation screens are generally accessible by the typical user.

When the user selects the documents to be printed, the transaction broker 220 sends a request with the application ID to the database 222 to execute a stored procedure. The stored procedure queries the database 222 to determine what documents have been requested and determine if the documents are ready for processing. The stored procedure then queries the database 222 to extract out all the information necessary for document processing. Multiple results are returned to the transaction broker 220. The results may include, for example: each document name for the application ID; document field name for every document name; and the value for each document field name. From this information received by the transaction broker 220, a request may be generated that contains only the fields necessary for document processing. The request record is received by the document-printing engine 226 with all the variables required for that product document. Upon receipt of the document, the process retrieves the appropriate document template from the document-printing database, inserts the variable data elements into the proper fields on the document template, and returns the completed record in standard document-printing post script print format or PDF format to the user. The documents are returned and stored in the database 222, at which time an index of documents to be printed displays onscreen for the user. Typically, the document requests are generated using XML commands. A user may access the “Closing and Document Printing” queue in the workflow. In accessing the queue, the user is typically referred to the oldest application for processing.

In addition to closing documents, the document engine 226 may produce any document associated with application processing including, but not limited to, approval letters, rejection letters, information request letters, legal requirement letters or forms, and any other applicable documents.

In an exemplary embodiment of the present invention, the Print Status feature lists all documents selected for printing within a certain time period, such as the last two days. The table contains a list of documents that have been selected by a user within the above mentioned time period. The status of each document may be provided.

In an exemplary embodiment of the present invention, the system also supports the printing of custom documents so that customers may supplement their standard electronic forms with their own product or company specific forms. Using an editor, the system allows the user to create and edit a variety of custom forms. Field placement, overall properties, and logos are all editable using the editor. A request record includes the necessary variables to fill in the generic document templates created with the editor.

In an exemplary embodiment of the present invention, an internal logic engine 224 provides the ability to associate documents with products, states, and organizations. This association allows the Select Documents/Print Status feature to determine which documents to present to the user based on the application. The feature provides a drop-down list of available lenders. The administrator selects a lender and is provided with the list of products associated with that lender. Once the administrator selects a product, the administrator chooses the product to apply the document logic and then defines the document logic using a set of multiple-select include/exclude boxes. The administrator may also choose a state or country with which to associate the documents. Additional features may be used to accommodate additional logic variables such as loan amount and organization.

Additionally, the loan origination and application processing system may use a third-party electronic fulfillment letter generator to send letters to consumers based on pre-determined mailing parameters. Letters may be sent after decisioning, indicating a pass or fail outcome. Additionally, the letters may be sent after certification or at any time within the workflow sequence.

In an exemplary embodiment of the present invention, the loan origination and application processing system provides necessary functions for final application processing including, but not limited to, payment calculation, fee assessment, insurance fulfillment, and disbursement of funds. Users may also employ the document fulfillment functionality from within these screens.

Generally, the Payment Calculation processing includes the Payment feature that is used for setting closing information such as insurance options, deal parameters, taxes, and fees. Depending on the customer's requirements, automatic payment calculators may be incorporated into the closing process.

In an exemplary embodiment of the present invention, the system may fulfill insurance requirements through an automated insurance-eligibility assessment function that may be used to “pre-qualify” a consumer for insurance required for the application or product. Eligibility is based on state-specific insurance criteria, and is calculated after the payment calculation has been performed. Before calculating overall eligibility, the screen prompts the user to verify consumer data such as individual applicant eligibility, payment calculation, bank employee status, and maximum insurance levels. Additionally, the system may fulfill insurance requirements through manual selection of both the insurance company and the specific type of insurance sold via an insurance selection feature. Available insurance providers are selectable and may be organization-specific. Through the Insurance feature, the user may enter the number of payments, the certificate number, and the check remittance date.

Additionally, the system provides additional closing features. The Finance Disclosure feature permits a user to enter all the specific information regarding the term of a loan. The Amortization feature outputs in table-style format the payment history of a loan based on current parameters such as the annual percentage rate, term, and insurance. The Closing Administration feature offers various functions relating to the closing section, such as preparing reports. The Add/Modify Insurance Provider feature allows administrators to add or modify information about insurance providers and their corresponding coverage. The information is contained in a static table in the database 222. Different coverage per provider may be created or modified from the list of coverage types. The Document Setup feature assigns default values to certain fields associated with a closing. The default values for each field may be determined by the administrator. When a lender is selected by the administrator, the system provides a list of document fields that need to be defaulted. The fields may be organized by their related documents. If the default values are already available, they may be displayed.

In an exemplary embodiment of the present invention, the loan origination and application processing system provides automated booking services. Customers may use any of the pre-configured interfaces to existing servicing agents or may create custom interfaces to communicate with an internal system of record. Booking features include, but are not limited to, procedures and functionality for verifying loan information, for notifying consumers of the action taken, for any additional requirements yet to be met, and for booking the loan using either an automatic or manual process. Preferrably, the system generates booking requests in XML format. For every request, an acknowledgement is returned followed by a response indicating booking failure or success. Customers may choose a combination of external and company-internal booking systems.

In an exemplary embodiment of the present invention, the reporting function offers instant access to critical application data in a real-time environment. Through the reporting server 314, a wide range of pre-prepared reports are available as well as a limited number of ad hoc queries. Reports may be viewed on a secured website with encryption or may be transmitted via a secure socket connection or dedicated line directly to the customer's system. Standard reports may include summary information on all transactions and graphs to aid in quick analysis. Ad hoc reporting allows users to select instances of reports for a certain data range or other parameter. Reporting parameters are customer-specific and are typically defined prior to install.

In an exemplary embodiment of the present invention, feature permissions allow financial institutions to ensure that only certain users have access to specific functionality. Permission schemes may be explicitly defined and assigned with consideration. The permission structure of the system allows an administrator to assign specific functionalities to user groups that may contain any number of users.

Administrators may add and modify features in the system through the Administration feature. The Administration feature permits the administrator to create and assign features to a feature set. Feature sets are groups of features that cannot be separated because of dependency. A list of feature directories is provided to the administrator in a series of feature directories. By selecting a feature directory, they system provides a selection list of all the features in the directory. Selecting a particular feature provides any information in the database 222 concerning the feature. Features may then be assigned to a feature set by searching for a feature through the directories and adding the feature to the feature set list.

Typically, once individual features are assigned to a feature set, the system treats the set as an individual unit and, therefore, prevents a user from assigning permissions to the features on an individual basis. Feature sets may be used to assign permissions to relevant user groups. Additionally, administrators may assign specific field level permissions for features that contain a specific set of fields.

In an exemplary embodiment of the present invention, administrators may assign feature sets or groups to user groups to set up permission schemes for the user groups. Feature groups may be associated with multiple user groups and a user group may be associated with multiple feature groups. Generally, the administrator determines if the group of users is to have no access, read only access, or read/write access to the features. The feature set name and description may be accessed by the administrator and used to assign the feature set to a user group.

Once a relationship between a user group and a feature set has been made, the administrator may customize the relationship. The administrator may override the access level for each feature in the feature group as it was assigned to the relationship when it was first created. The Feature Group Override feature provides the administrator with the relationships between the user groups and the feature sets. The administrator may search for a user group and access the list of features associated with the group. Additionally, each user's permission level may be listed with regard to the feature. By checking the override checkbox, the administrator is provided with the options to select the specific permission level for the particular user or user group. For example, the administrator may change read only access for a particular feature to read/write access. The functionality allows an administrator to maintain a reasonable number of feature groups without having to create a different group each time a slight variation is needed with regard to the user groups. Additionally, the administrator may control which fields within the feature the user can view. By determining which field may be viewed by the user, the administrator may prevent access to sensitive fields by certain or all users.

Additionally, a user may belong to different user groups and, accordingly, may be assigned multiple permissions schema for a particular feature or feature set. The system provides the user with the highest access granted to that user for the specific feature. Permissions for a user are compiled each time a user logs into the system. Thus, an administrator may change the permissions setup and the changes will be instituted when the user logs back into the system.

In an exemplary embodiment of the present invention, the loan origination and application processing system provides product parameter permissions functionality that imposes limitations on user permissions to field values used by the financial institution. The product parameter permissions functionality forces users to stay within assigned limits when processing applications. For example, a user may only have permission to approve loan values of $10,000. If the user tries to enter a value over $10,000, the application will be withdrawn from the user and given to a senior underwriter for approval.

Additionally, configuring product parameter permissions may be available to the administrator. The administrator may assign minimum and maximum values for the fields of a user group. Such limits may be specific to each product that the user group processes. The Product Parameter Permissions feature provides the administrator with selection tools to find the appropriate feature for configuration. The administrator may set minimum and maximum limits for each of the fields of the feature as it pertains to a particular user or user group.

When a user edits a field that has been configured using product parameter permissions, the field is validated when submitted. If the value within the fields falls outside the specific range defined for the user, the application does not get processed, but rather is routed to a more senior user. Such routing may be instituted in the system workflow. Fields generally have default minimum and maximum limits for purposes of product parameter permissions.

In an exemplary embodiment of the present invention, the loan origination and application processing system provides a component to assist users in meeting regulations set by the Office of Foreign Assets Control (“OFAC”) and the Uniting and Strengthening America by Providing Appropriate Tools Required to Intercept and Obstruct Terrorism (“USA PATRIOT”) Act. Typically, the component may be configured through the Vendor interface. The component provides users the ability to screen applicants against several national and international databases. The system provides users with customizable options for this component such as choosing the match threshold, selecting the match parameters, choosing the appropriate external database system to utilize, selecting the placement of the component in the workflow, selecting the routing paths of the workflow, and selecting the notification method for a database match. The OFAC and USA PATRIOT component may be an automated task or a stand-alone check.

The OFAC and USA PATRIOT component of the system is designed to provide assistance in identifying applications that may be of issue. The Product Management feature allows the user to configure the match threshold and select the appropriate external database. The user then configures the placement of this task within the workflow. The transaction broker 220 performs the check as an automated task or a stand-alone request and determines if the applicant has already been screened or determines if the applicant should be re-screened based on updates to the external database. When necessary, the transaction broker 220 may make a request to the external database and wait to receive a response. The transaction broker 220 may notify the user of matches through several methods. For example, the transaction broker 220 may notify the user through a backend report, email notification, or an instant response. The local database 222 stores the threshold and vendor service by product. Additionally, the local database 222 may store the response from the external database as well as information about external database updates. The results from screening are displayed for the user and the user is enabled to clear a false-positive result or to print data for reporting on a true-positive result.

To run the OFAC and USA PATRIOT component as an automated task, the administrator may configure the component as automated in the workflow. During configuration, the administrator determines proper routing and overdue routing for the workflow with regard to the component. While defining products in the system, the administrator selects an external database service for the OFAC and USA PATRIOT component, sets the match threshold, configures the match parameters and any notification methods. The external service determines what data applicants may be screened against. The match threshold determines whether the application should be directed to the OFAC or USA PATRIOT queue for further processing. The match threshold may be configured to require a minimum or maximum limit. For example, the match threshold might need to be between a score range of 50 and 95. External database services may require a certain match threshold level, such as 75.

In an exemplary embodiment of the present invention, the OFAC and USA PATRIOT components are executed at a designated point in the workflow during an automated configuration. The logic engine 224 calls the specific check from the database 222 through the transaction broker 220. The transaction broker 220 executes a procedure stored in the database 222 to determine if the OFAC and USA PATRIOT checks need to be conducted. If the transaction broker 220 determines that a check is necessary based on the minimum threshold, then the stored procedure returns the data required to make a request to the external database service. The transaction broker 220 makes a request with the external database and stores the request in the local database 222. If the external database returns a positive result, the application is flagged. The transaction broker 220 stores the response to the local database 222. The transaction broker 220 sends the response to the logic engine 224. The logic engine 224 queries the database 222 to determine where to route the application for further processing. If the application has been flagged, the logic engine 224 directs the application to the OFAC or USA PATRIOT queues and halts workflow on the application. A user may then access either queue to determine if the application had a false-positive or true-positive result. The user may select an application from the queues and the system will direct the user to the OFAC or USA PATRIOT review screen. The user may investigate the match by examining the list details for each application. If the list of matches is identified as a false-positive, then the user may clear the application from the list and send the application back to the workflow. If the user determines that the match is a true-positive, then a report may be printed that contains the application information. The user is provided with the Report containing application information and match information for reporting purposes. Additionally, the Report may contain the contact numbers to the relevant governmental agencies. Next, the application may be closed and the Office of Foreign Assets Control and the Department of Commerce may be contacted. The user may manually submit the report to the appropriate institution regarding the application.

During a stand-alone configuration, a request containing relevant information pertaining to the external database service may be sent to the transaction broker 220. The relevant information is determined by the attribute requirements set by the external database service. The transaction broker 220 communicates with the external database service. The transaction broker 220 receives a response from the external database service and sends notification, if necessary, to the user. The response is returned to the process making the initial request from the transaction broker 220. Available methods of notification include email notification and backend reports. File updates from the external database service are inserted into the local database 222 for future processing.

While the invention has been described in detail with particular reference to preferred embodiments thereof, it will be understood that variations and modifications can be effected within the scope of the invention as defined in the appended claims.

What is claimed is:

1. An application processing system comprising:
a data storage unit adapted to receive, store, and provide application data associated with an application;
a logic engine in communication with said data storage unit and adapted to communicate with a plurality of decision engines and to direct said application data to at least one of said plurality of decision engines and to receive decision data from said at least one of said plurality of decision engines.

2. The application processing system of claim 1, further comprising:
a checking module adapted to validate said application data; and
said logic engine further adapted to receive decision data and to direct approved applications to an approved application document production engine.

3. The application processing system of claim 2, further comprising:
said logic engine further adapted to direct rejected applications to a rejected application document production engine, and to direct pending applications to a pending applications queue for further processing.

4. The application processing system of claim 2, wherein said checking module is adapted to perform a fraud check.

5. The application processing system of claim 2, wherein said checking module is adapted to perform a duplicates check.

6. The application processing system of claim 1, wherein the logic engine is further adapted to allow user customization of a logic engine workflow.

7. The application processing system of claim 6, wherein said logic engine workflow determines the order and steps of processing an application.

8. The application processing system of claim 1, further comprising:
a transaction broker adapted to coordinate communications between said data storage unit, logic engine, and decision engine.

9. A method of processing an application comprising the steps of:
receiving application data;
validating application data;
providing application data to one of a plurality of decision engines; and
receiving decision data from said one of said plurality of decision engines indicating the status of a decision.

10. The method of claim 9, further comprising the step of:
providing application data to a first document production engine in response to an approved decision from the decision engine.

11. The method of claim 9, further comprising the step of:
providing application data to a second document production engine in response to a declined decision from the decision engine.

12. The method of claim 9, further comprising the step of:
providing application data to a pending application queue when said decision engine does not approve and does not decline the application.

13. The method of claim 12, further comprising the step of:
analyzing the application data and decision data for each application in the pending application queue.

14. The method of claim 9, wherein the step of validating the application data comprises the steps of:
identifying an applicant based on said application data;
determining whether the applicant is a currently pending applicant; and
directing the application data to a duplicate application queue if the current application is a duplicate application.

15. The method of claim 9, wherein the step of validating the report data comprises the steps of:
determining whether the application data indicates potential fraud; and
directing the application to a fraud queue if the report data indicates potential fraud.

16. The method of claim 9, wherein said step of providing application data to one of a plurality of decision engines comprises providing application data to a decision engine capable of receiving report data from a credit reporting bureau.

17. The method of claim 9, wherein said step of providing application data to one of a plurality of decision engines comprises providing application data to a decision engine capable of receiving report data from a government reporting bureau.
